(19) United States
(12) Patent Application Publication
(10) Pub. No.: US 2023/0252620 A1
(43) Pub. Date: Aug. 10, 2023

(54) INSPECTION DEVICE, LEARNED MODEL GENERATION METHOD, AND INSPECTION METHOD

(71) Applicant: ANRITSU CORPORATION, Kanagawa (JP)

(72) Inventors: Koetsu TSUNODA, Kanagawa (JP); Takeshi YAMAZAKI, Kanagawa (JP)

(21) Appl. No.: 18/160,778

(22) Filed: Jan. 27, 2023

(30) Foreign Application Priority Data
Feb. 7, 2022 (JP) 2022-017366

(51) Int. Cl. G06T 7/00; G01N 23/18; G01N 23/083

(52) U.S. Cl. CPC G06T 7/001; G01N 23/18; G01N 23/083; G06T 7/0008; G01N 2223/401; G06T 2207/20081; G06T 2207/30128; G06T 2207/10116; G06T 2207/20212

(57) ABSTRACT

To improve accuracy of inspecting a quality state of an inspection object. An inspection device 1 includes: an image storage unit 21 that captures a plurality of images having different input channels for an inspection object W under an imaging condition corresponding to each input channel, and stores multiple inspection images obtained by the capturing and combining the plurality of images of the inspection object W; and a determination unit 24 that obtains a defective quality degree for the multiple inspection images stored in the image storage unit 21 based on a learned model 22 created in advance by learning using an image having a same imaging condition as the multiple inspection images, and determines a quality state of the inspection object W by comparison between the defective quality degree and a preset threshold.

### TECHNICAL FIELD

The present invention relates to an inspection device that inspects a quality state required for an inspection object, a learned model generation method, and an inspection method.

### BACKGROUND ART

For example, an X-ray inspection device disclosed in the following Patent Document 1 is known as a device for inspecting a quality state required for an inspection object using X-rays. The X-ray inspection device disclosed in Patent Document 1 stores X-ray image data from an X-ray detector in an X-ray image storage unit, generates, using a pseudo image generation model, pseudo X-ray image data in another energy band including a predetermined energy band for various learning target article type, based on a learned result of the X-ray image data in a plurality of different energy bands, creates, by an image creation unit, a pseudo transmission image in another energy band using the pseudo image generation model based on the X-ray image data in a predetermined energy band of the inspection object, and determines, by a determination unit, a quality state of the inspection object based on the X-ray image data in the predetermined energy band of the inspection object and the pseudo transmission image in another energy band created an image creation unit.

### RELATED ART DOCUMENT

### Patent Document

[Patent Document 1] JP-A-2021-148486

### DISCLOSURE OF THE INVENTION

### Problem that the Invention is to Solve

However, in the conventional inspection device disclosed in Patent Document 1, the transmission image used for determination is one grayscale image, and an amount of information for determination is small, resulting in limitation to improvement in accuracy of inspecting a quality state of the inspection object.

Accordingly, the present invention has been made in view of the above problems, and an object of the present invention is to provide an inspection device capable of improving accuracy of inspecting a quality state of an inspection object, a learned model generation method, and an inspection method.

### Means for Solving the Problem

In order to achieve the above object, an inspection device according to a first aspect of the present invention includes: an image storage unit 21 that captures a plurality of images having different input channels for an inspection object W under a predetermined imaging condition corresponding to each input channel, and stores multiple inspection images in which the plurality of images of the inspection object obtained by the capturing are combined; and

a determination unit 24 that obtains a defective quality degree for the multiple inspection images stored in the image storage unit based on a learned model 22 created in advance by learning using an image having a same imaging condition as the multiple inspection images, and determines a quality state of the inspection object by comparison between the defective quality degree and a preset threshold.

An inspection device according to a second aspect of the present invention is the inspection device according to the first aspect

in which the predetermined imaging condition includes at least position information indicating an imaging position of the inspection object for each input channel.

An inspection device according to a third aspect of the present invention is the inspection device according to the first aspect

in which the learned model is associated with the imaging condition for an image used for learning.

An inspection device according to a fourth aspect of the present invention is the inspection device according to the first aspect

in which the learned model is learned for each type of the inspection object with respect to the image having a same imaging condition as the multiple inspection images including at least images with a defective quality.

An inspection device according to a fifth aspect of the present invention is the inspection device according to the first aspect

in which the multiple inspection images are images obtained by spectroscopy of light transmitting through the inspection object.

In addition, an inspection device according to a sixth aspect of the present invention is the inspection device according to the second aspect

in which the multiple inspection images are images obtained by spectroscopy of light transmitting through the inspection object.

In addition, an inspection device according to a seventh aspect of the present invention is the inspection device according to the third aspect in which

the multiple inspection images are images obtained by spectroscopy of light transmitting through the inspection object.

In addition, an inspection device according to an eighth aspect of the present invention is the inspection device according to the fourth aspect

in which the multiple inspection images are images obtained by spectroscopy of light transmitting through the inspection object.

A learned model generation method according to a ninth aspect of the present invention includes: a step of acquiring a non-defective image of an inspection object W and an image with only defective quality of the inspection object as learning images;

a step of creating a learning defective quality synthesis image in which the image with only defective quality is synthesized with the non-defective image of the inspection object using the learning image and a learning defective quality label showing a defective quality position in the learning defective quality synthesis image; and

a step of creating a learned model 22 by performing machine learning of the learning defective quality synthesis image.

An inspection method according to a tenth aspect of the present invention includes: a step of determining a quality state of an inspection object W by capturing a plurality of images having different input channels for the inspection object under a predetermined imaging condition corresponding to each input channel, obtaining a defective quality degree for multiple inspection images in which the plurality of images of the inspection object obtained by the capturing are combined, based on a learned model 22 created using an image having a same imaging condition as the multiple inspection images by the learned model creation method of the ninth aspect, and comparing the defective quality degree and a preset threshold.

### Advantage of the Invention

According to the present invention, it is possible to improve the inspection accuracy of the quality inspection of the inspection object to be transported by making the determination learned by using a plurality of types of images.

### BRIEF DESCRIPTION OF THE DRAWINGS

FIG. 1 is a block diagram of an inspection device according to the present invention.

FIG. 2 is a flowchart of a learning phase when the inspection device according to the present invention inspects presence/absence of a foreign matter on an inspection object.

FIG. 3 is a flowchart of an inference phase when the inspection device according to the present invention inspects presence/absence of the foreign matter on the inspection object.

FIG. 4 is a view showing a creation example of a foreign matter synthesis image used during learning when the inspection device according to the present invention inspects presence/absence of the foreign matter on the inspection object.

FIG. 5 is a view showing examples of a learning image and a learning foreign matter label used during learning when the inspection device according to the present invention inspects presence/absence of the foreign matter on the inspection object.

FIG. 6 is a view showing an example of an inference image when the inspection device according to the present invention inspects presence/absence of the foreign matter on the inspection object.

FIG. 7 is an explanatory view of an image processing unit when the inspection device according to the present invention inspects presence/absence of the foreign matter on the inspection object.

FIG. 8 is an explanatory view of a determination unit when the inspection device according to the present invention inspects presence/absence of the foreign matter on the inspection object.

FIG. 9 is a view of display examples of a display unit when the inspection device according to the present invention inspects presence/absence of the foreign matter on the inspection object.

FIG. 10 is a flowchart of the inference phase when the inspection device according to the present invention inspects a shape defect of the inspection object.

FIG. 11 is a view showing examples of a learning image and a learning shape defect label used during learning when the inspection device according to the present invention inspects a shape defect of the inspection object.

FIG. 12 is an explanatory view of the image processing unit when the inspection device according to the present invention inspects a shape defect of the inspection object.

FIG. 13 is an explanatory view of the determination unit when the inspection device according to the present invention inspects a shape defect (chipping) of the inspection object.

FIG. 14 is a view of display examples of the display unit when the inspection device according to the present invention inspects a shape defect (chipping) of the inspection object.

FIG. 15 is an explanatory view of the determination unit when the inspection device according to the present invention inspects a shape defect (bending) of the inspection object.

FIG. 16 is a view of display examples of the display unit when the inspection device according to the present invention inspects a shape defect (bending) of the inspection object.

FIG. 17 is a diagram showing a configuration example of an inspection device for inspecting a shape defect (length) of an inspection object.

FIG. 18 is an explanatory view of the image processing unit when the inspection device of FIG. 17 inspects a shape defect (length) of the inspection object.

### BEST MODE FOR CARRYING OUT THE INVENTION

Hereinafter, a mode for carrying out the present invention will be described in detail referring to the accompanying drawings.

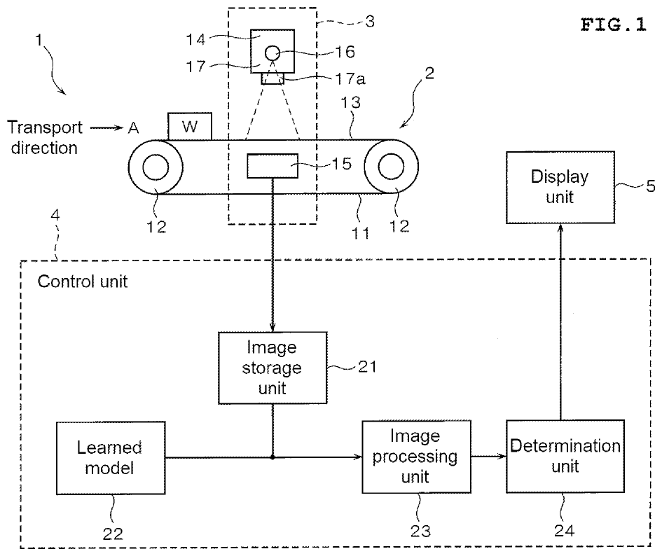

As shown in FIG. 1, an inspection device 1 is schematically configured by including a transport unit 2, an image acquisition unit 3, a control unit 4, and a display unit 5. The inspection device 1 performs inspection (for example, inspection of presence/absence of foreign matter contained in an inspection object W such as packaged food) of the inspection object W by acquiring multiple inspection images in which a plurality of images (grayscale images) of the inspection object W are combined, in which the plurality of images are obtained by capturing the plurality of images having different input channels for the inspection object W of a type of a product to be inspected that is transported by the transport unit 2, processing the multiple inspection images for each pixel based on a learned model (calculation formula) created using the image under an imaging condition the same as each input channel for the multiple inspection images, obtaining a defective quality degree showing a probability of a defective quality (for example, foreign matter degree, shape defect degree, or the like), and determining a quality state of the inspection object W by comparison between the obtained defective quality degree and a preset threshold.

In addition, the “quality state” in this example means suitability of quality, physical quantity, and the like required for the inspection object W as a product. Specifically, examples of the “quality state” include presence/absence of foreign matter (bone, metal, or the like) contained in the inspection object W, excess or deficiency of contents, different types of contents, and shape defect of contents.

The transport unit 2 sequentially transports the inspection object W at a predetermined interval in a transport direction A, and has a configuration in which, for example, a loop-shaped transport belt 11 is wound around a plurality of transport rollers 12, and a conveyor, which can sequentially transport the inspection object W to the right in FIG. 1 by an upper running section 13 of the transport belt 11, is supported to a casing (not shown). The transport roller 12 is rotated by a motor (not shown) and controlled by the control unit 4 to achieve a predetermined transport speed.

The image acquisition unit 3 acquires a learning image used in a learning phase to be described later or an inference image of the inspection object W used in an inference phase to be described later, and serves as an inspection unit that inspects a quality state of the inspection object W transported by the transport unit 2.

The image acquisition unit 3 includes an X-ray generator 14 that generates, for example, X-rays in a predetermined energy band that transmits through the inspection object W transported by the transport unit 2, when the learning image and the inference image are acquired as an X-ray image, and an X-ray detector 15 that is disposed immediately below the upper running section 13 of the transport belt 11 of the transport unit 2 to face the X-ray generator 14.

The X-ray generator 14 generates X-rays having a wavelength and intensity corresponding to a tube current and a tube voltage of a known X-ray tube 16, and allows the X-rays to pass through an X-ray window 17a of an enclosure 17, so as to irradiate the inspection object W or a sample (non-defective work of the inspection object W, or foreign matter) on the transport belt 11 with fan-beam X-rays orthogonal to the transport direction of the transport unit 2.

The tube current and tube voltage of the X-ray tube 16 has a set value that may be adjusted according to a material or size (in particular, dimension in a direction in which the X-rays transmit through) of the inspection object W to be inspected or the sample, and has a set value that is determined and selected so that an appropriate contrast can be obtained by test imaging using the inspection object W for a new type.

The X-ray detector 15 has, for example, detection elements, which includes a scintillator, which is a phosphor, and a photodiode or a charge-coupled element, arranged in an array at a predetermined pitch in a width direction of a transport path of the transport unit 2, includes an X-ray line sensor camera so as to detect X-rays at a predetermined resolution, and is arranged at a predetermined position in a transport direction that corresponds to a position where X-rays are irradiated from the X-ray generator 14.

The X-ray detector 15 detects the X-rays, which is irradiated from the X-ray generator 14 and transmits through the inspection object W or the sample, for each predetermined transmission region corresponding to the detection element, and converts the X-rays into an electric signal according to a transmission amount of the X-rays to output an X-ray detection signal for each transmission region.

Here, a method for acquiring a learning image from an X-ray image when presence/absence of a foreign matter on the inspection object W is inspected will be described. First, a tube current and tube voltage of the X-ray tube 16 for a certain type of the inspection object W are set by test imaging, and the transport unit 2 is driven and controlled. That is, imaging conditions for acquiring an X-ray image for a certain type of the inspection object W are set, and when 1,000 non-defective images and 50 images of only foreign matter (bone) are acquired as learning images, first, a low-energy image (non-defective product)_(1ch) and a high-energy image (non-defective product)_(1ch) are acquired at the same timing by irradiating non-defective work of the inspection object W with the X-rays from the X-ray generator 14, for example, from a position at a predetermined height. This operation is executed 1,000 times to acquire 1,000 low-energy images (non-defective products) and 1,000 high-energy images (non-defective products). As a result, one low-energy image (non-defective product) and one high-energy image (non-defective product) can be acquired in one execution.

Similarly, a low-energy image (only one foreign matter)_(1ch) and a high-energy image (only one foreign matter)_(1ch) are acquired at the same timing by irradiating work of only foreign matter (for example, only one piece of bone) with the X-rays from the X-ray generator 14, for example, from a position at a predetermined height (the same position as the non-defective image). This operation is executed 50 times to acquire 50 low-energy images (only one foreign matter) and 50 high-energy images (only one foreign matter). As a result, one low-energy image (only one foreign matter) and one high-energy image (only one foreign matter) can be acquired in one execution.

In this way, learning images are acquired under predetermined imaging conditions for a certain type of the inspection object W.

Next, multiple inspection images are created by combining three channels (hereinafter, “3ch”) of images from the learning images described above. In this case, the low-energy images and high-energy images of a non-defective work, and one database image of a foreign matter is prepared.

Here, the low-energy and high-energy images of a non-defective work are obtained at the same timing by irradiating the non-defective work of the inspection object W with the X-rays from the X-ray generator 14, and the database image is the image obtained by cutting from a plurality of low-energy and high-energy images of only foreign matter at the same timing.

The 3ch multiple inspection images are combined based on the low-energy image, the high-energy image and the difference image of the two images. The low-energy image and high-energy image are created by synthesizing the database images of a foreign matter while being shifted to random positions on one non-defective image. The creation of the plurality of multiple inspection images from the one non-defective image is performed on the prepared plurality of non-defective images, for example, several tens of/non-defective images. Furthermore, a plurality of other low-energy and high-energy images, both of which are captured at the same timing, of only a foreign matter is prepared, and multiple inspection images in which the 3ch images are combined are created using the same method.

Further, a method for creating a multiple inspection image by combining the 3ch images will be described with specific numerical examples. First, as learning images, 1,000 low-energy images (non-defective product)_(1ch), 1,000 high-energy images (non-defective product)_(1ch), 50 low-energy images (only one foreign matter)_(1ch), and 50 high-energy images (only one foreign matter)_(1ch) are obtained respectively.

Then, 50 low-energy images (only one foreign matter)_(1ch) and 50 high-energy images (only one foreign matter)_(1ch) are used to create a database image of a foreign matter, which is obtained by cutting only a region where the foreign matter is shown, with the low energy and the high energy, respectively. That is, one low-energy image (50 foreign matters are shown)_(1ch) and one high-energy image (50 foreign matters are shown)_(1ch) are created.

Next, a foreign matter synthesis image is created by synthesizing one low-energy image (which is obtained by synthesizing a foreign matter with a non-defective product)_(1ch) and one high-energy image (which is obtained by synthesizing a foreign matter with a non-defective product)_(1ch) from one low-energy image (non-defective product)_(1ch), one high-energy image (non-defective product)_(1ch), one low-energy image (50 foreign matters are shown)_(1ch), and one high-energy image (50 foreign matters are shown)_(1ch).

When the foreign matter is synthesized with the non-defective image, coordinate data (labels) of the foreign matter are simultaneously output under conditions, such as foreign matter position: random position on non-defective work and the same position as the (low- and high-) energy images, foreign matter rotation angle: random angle from 0 to 360 degrees, and the number of foreign matters: randomly selected foreign matter (one or a plurality of foreign matters randomly selected from 50 foreign matters).

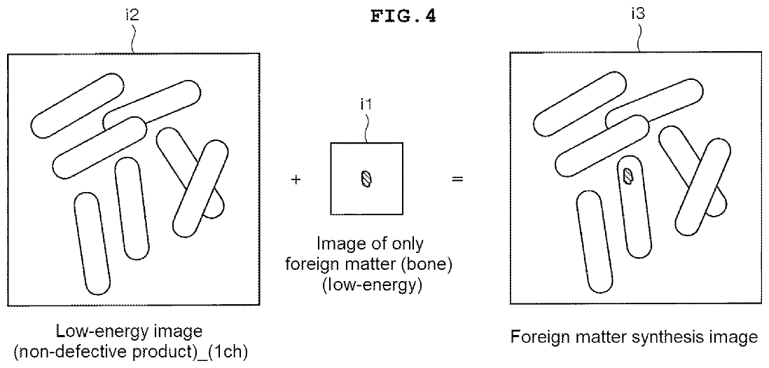

Here, FIG. 4 shows an example of a case in which a (low-energy) image i1 of only one foreign matter (one piece of bone) is selected from one low-energy image (50 foreign matters are shown)_(1ch), and the selected image i1 of only one foreign matter (one piece of bone) is synthesized with one low-energy image i2 (non-defective product)_(1ch) to create a foreign matter synthesis image i3.

Then, a difference between the two is made using one low-energy image (synthesis of a foreign matter with a non-defective product)_(1ch) and one high-energy image (synthesis of a foreign matter with a non-defective product)_(1ch). As a result, one difference image (difference between the low-energy image and the high-energy image obtained by synthesizing a foreign matter with a non-defective product)_(1ch) is created.

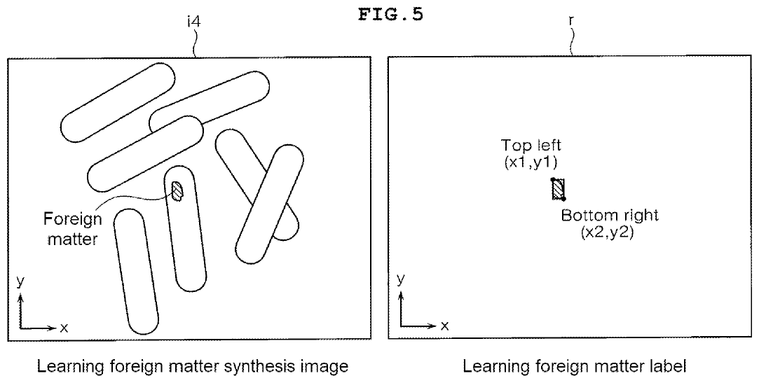

Further, for example, one multiple inspection image (1ch component: low energy, 2ch component: high energy, and 3ch component: difference) (3ch) including a foreign matter (a portion indicated by diagonal lines in the drawing) as shown in FIG. 5 and the coordinate data of a foreign matter are created as a learning foreign matter synthesis image i4 and a learning foreign matter label r, from one low-energy image (synthesis of a foreign matter with a non-defective product)_(1ch), one high-energy image (synthesis of a foreign matter with a non-defective product)_(1ch), and one difference image (difference between the low-energy image and the high-energy image obtained by synthesizing a foreign matter with a non-defective product)_(1ch).

The above operation is executed 1,000 times to acquire 1,000 multiple inspection images (1ch component: low energy, 2ch component: high energy, and 3ch component: difference)_(3ch) and 1,000 foreign matter coordinate data (positions of the low energy and high energy are common) as the learning foreign matter synthesis image i4 and the learning foreign matter label r.

Next, a method for acquiring an inference image from an X-ray image will be described. When an inference image is acquired from an X-ray image, it is required that the case of acquiring a learning image described above and the imaging conditions (configurations and positions of the X-ray generator 14 and the X-ray detector 15, X-ray irradiation conditions, X-ray detection conditions, transport speed, and the like) of an image by the image acquisition unit 3 are the same. To specifically describe acquisition of the low-energy image and the high-energy image, for example, the inspection object W is irradiated with X-rays from one X-ray source of the X-ray generator 14, for example, from directly above at a predetermined height, the X-rays transmitted through the inspection object W is detected using two X-ray detectors 15 with X-ray filters having different ray qualities (which refers to a type or energy of radiation during irradiation), and images detected by the two X-ray detectors 15 are treated as a low-energy image and a high-energy image, respectively, thereby creating a difference image from the two images.

Alternatively, after using X-ray filters, the inspection object W is irradiated with the X-rays having different ray qualities from the X-ray generator 14, for example, from directly above at a predetermined height, the X-rays transmitted through the inspection object W are detected using two X-ray line sensor cameras for different energies, and images detected by the two X-ray line sensor cameras are treated as a low-energy image and a high-energy image, respectively, thereby creating a difference image from the two images (see JP-A-2002-168803 and Japanese Patent No. 5297087).

Alternatively, the inspection object W is irradiated with low-energy X-rays and high-energy X-rays from the two X-ray generators 14, respectively, for example, from directly above at a predetermined height, and the X-rays transmitted through the inspection object W are detected using the corresponding two X-ray line sensor cameras, respectively, thereby creating a difference image from the low-energy image and the high-energy image detected by the two X-ray line sensor cameras (see Japanese Patent No. 5706724 and Japanese Patent No. 5775406).

Alternatively, a single photon counting-type X-ray detector capable of simultaneously acquiring a low-energy image and a high-energy image may be used.

When using two X-ray line sensor cameras, the imaging conditions may include at least an arrangement interval of the two X-ray line sensor cameras and a transport speed of the transport unit 2 (transport belt 11), or a value determined based on the arrangement interval and the transport speed. Accordingly, a difference in an imaging position of the inspection object W in the image acquired by each X-ray line sensor camera can be grasped. If the difference in the imaging position can be quantitatively grasped, various calculation processing can be performed to reduce an influence of the difference, such that the position information indicating an imaging position of the inspection object W, which is one of the imaging conditions, is technically synonymous with “having the same position information”.

In addition, when using the photon counting-type X-ray detector, the imaging conditions may include at least an energy threshold for counting photons. Since the photon counting-type X-ray detector outputs images showing different transmission characteristics for each energy band according to the set energy threshold, it is convenient in principle because the imaging position of the inspection object W is the same in the low-energy image and the high-energy image.

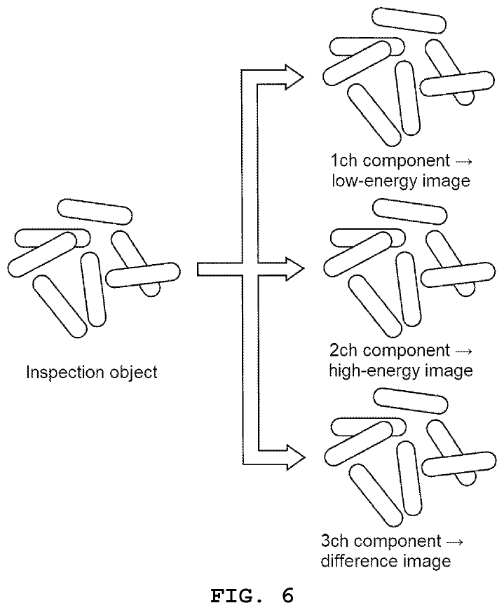

As shown in FIG. 6, three X-ray images for the inspection object W are combined to acquire the multiple inspection images as an inference image i5, in which the low-energy image is regarded as 1ch component, the high-energy image is regarded as 2ch component, and the difference image is regarded as 3ch component.

The control unit 4 comprehensively controls each unit for inspecting a quality state of the inspection object W, and includes an image storage unit 21, a learned model 22, an image processing unit 23, and a determination unit 24. Various parameters for operating the transport unit 2, the inspection unit 3 (image acquisition unit 3), and the display unit 5 are stored, and various data are processed. Particularly, as for the operation of the transport unit 2 or the inspection unit 3 (image acquisition unit 3), an inspection parameter for each type of the inspection object W to be inspected is set in association with a product type number showing each product type.

The inspection parameter includes the learned model (calculation formula) applied to the multiple inspection images obtained for an image when the inspection object W is captured, or a threshold for determining a quality state.

The image storage unit 21 stores the inference image i5 acquired by the image acquisition unit 3 using the inspection parameter of the product type set for the inspection object W to be inspected. As described above, the inference image i5 consists of a multiple inspection image in which for example, the three X-ray images are combined, and the low-energy image is regarded as 1ch component, the high-energy image is regarded as 2ch component, and the difference image (difference between the low-energy image and the high-energy image) is regarded as 3ch component.

The learned model 22 is a trained model created by executing a learning phase, which will be described later, on an external terminal device such as a personal computer, using the 3ch multiple inspection image based on the learning image. This learned model 22 is used when calculating a foreign matter degree: K as a defective quality degree of the inference image i5 of the inspection object W in an inference phase to be described later. A foreign matter degree is a value showing a probability that the foreign matter is present. Data transfer of the learned model 22 between the inspection device 1 and the external terminal device is performed, for example, via a network or an external storage medium such as a USB memory. In addition, the learned model 22 is associated with the imaging condition for an image used for learning. By associating the imaging conditions, if the inspection parameter for each type of the inspection object W to be inspected has the same type and the same imaging condition, the same type of the learned model 22 can be used without generating a new learned model 22 (for example, this is effective, for example, when the new inspection object to be inspected has the same type and different volume or number of contents, or in a case of production where only packages are different).

The image processing unit 23 executes image processing for predetermined determination processing on image data of the inference image i5 (multiple inspection image in which the 3ch images are combined) stored in the image storage unit 21, based on the learned model 22 corresponding to a type of product to be inspected (learned model created from a learning image under the same imaging conditions as the inference image i5).

The determination unit 24 executes the determination processing of a quality state of the inspection object W (for example, determination processing of presence/absence of a foreign matter) based on the image data processed by the image processing unit 23.

Although not shown, the control unit 4 includes transport control means for controlling a transport speed or transport interval of the inspection object W by the transport belt 11 of the transport unit 2, and detection control means for controlling an X-ray irradiation intensity or irradiation period of the inspection unit 3 or controlling an X-ray detection period a detection period of each inspection object W using the X-ray line sensor of the X-ray detector 15 according to the transport speed of the inspection object W.

The display unit 5 includes various displays such as a liquid crystal display, and displays and outputs a determination result of the determination unit 24.

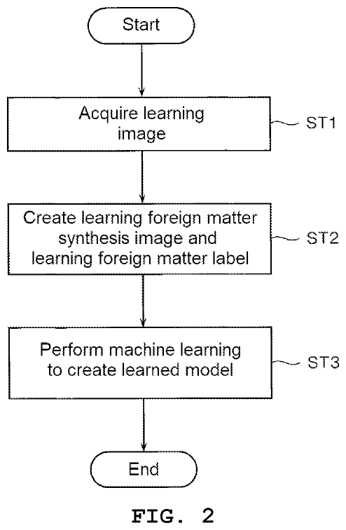

Next, a learning phase executed to create the learned model 22 will be described with reference to a flowchart of FIG. 2.

In the learning phase, learning is performed using the 3ch multiple inspection image consisting of an image having the same imaging condition as the inference image i5, that is, three images (for example, 1ch component: low-energy image, 2ch component: high-energy image, and 3ch component: difference image created from the low-energy image and the high-energy image) obtained from the image having the same position information and different input channel. This learning is performed for each product type of the inspection object W to be inspected.

As shown in FIG. 2, in the learning phase, a learning image is acquired first (ST1). Specifically, as the learning image, the inspection device 1 acquires 1,000 non-defective images and 50 images of only foreign matter (one piece of bone) from an X-ray image under a predetermined imaging condition, as described above.

Next, a learning foreign matter synthesis image i4 and a learning foreign matter label r are created (ST2). In creating the learning foreign matter synthesis image i4 and the learning foreign matter label r, when a foreign matter detection algorithm is created using deep learning, an NG image (an image including a foreign matter) and coordinate data (labels) of a foreign matter are required as learning teacher data.

The coordinate data (label) of a foreign matter herein is data indicating a position of a foreign matter portion on the NG image, and refers to text file data in which the top left X-Y coordinates and the bottom right X-Y coordinates are recorded when a frame circumscribing the image of the foreign matter portion is created.

When the coordinate data (label) of a foreign matter is extracted from the NG image, it is required to manually specify a coordinate position of many foreign matters by a person, which is not realistic in deep learning for requiring thousands of images.

Therefore, in this example, the learning foreign matter synthesis image i4 is created by synthesizing the images using the non-defective image and a foreign matter image captured individually, and simultaneously, the coordinate data (label) of the foreign matter portion is created as the learning foreign matter label r, thus achieving work efficiency.

Therefore, a database image of a foreign matter obtained by cutting a region where the foreign matter is shown is created in advance from the 50 images of only foreign matter (one piece of bone) acquired in advance, and when the database image is synthesized with the non-defective image, one or a plurality of foreign matters are randomly selected from the foreign matters of the database image.

Then, when the database image of a foreign matter is synthesized with the non-defective image, a total of 1,000 foreign matter synthesis images are created by setting the foreign matter position to a random position on non-defective work and randomly fluctuating the foreign matter rotation angle from 0 to 360 degrees.

When creating a foreign matter synthesis image, both the low-energy image and the high-energy image consisting of the X-ray image are used, and the X-ray image is extended to 3ch to combine three images, thereby creating the multiple inspection image in the format of the multiple inspection image, in which the low-energy image is regarded as 1ch component, the high-energy image is regarded as 2ch component, and the difference image (difference between the low-energy image and the high-energy image) is regarded as 3ch component.

When the database image of a foreign matter is synthesized with the non-defective image, an image regarded as the same channel of components is respectively used. In addition, when synthesizing the database image of a foreign matter with the non-defective image, a foreign matter label can be obtained from the specified coordinate data of the database image of a foreign matter by a coordinate position in which the database image of a foreign matter is arranged. Furthermore, when the database image of a foreign matter is rotated, the coordinate data of the database image of a foreign matter is obtained by coordinate transformation.

Then, machine learning of the foreign matter synthesis image is performed using a plurality of multiple inspection images created by the above method to create a learned model (ST3). That is, learning is performed by performing a convolution operation on the foreign matter synthesis image using the plurality of multiple inspection images and outputting the resulting foreign matter degree (probability of foreign matter) K to create a learned model 22 consisting of a calculation formula for producing a better result.

Specifically, learning is performed using 1,000 multiple inspection images (learning foreign matter synthesis image i4 extended to 3ch) and 1,000 coordinate data of a foreign matter (learning foreign matter label r) corresponding to respective multiple inspection images, to create the learned model 22. In this case, when an image of a workpiece (with foreign matter) is input, learning is performed to output a foreign matter position (top left X-Y coordinates and bottom right X-Y coordinates) and a foreign matter degree K (0<K<1.0) (as the value of K is increased, it is regarded as a foreign matter).

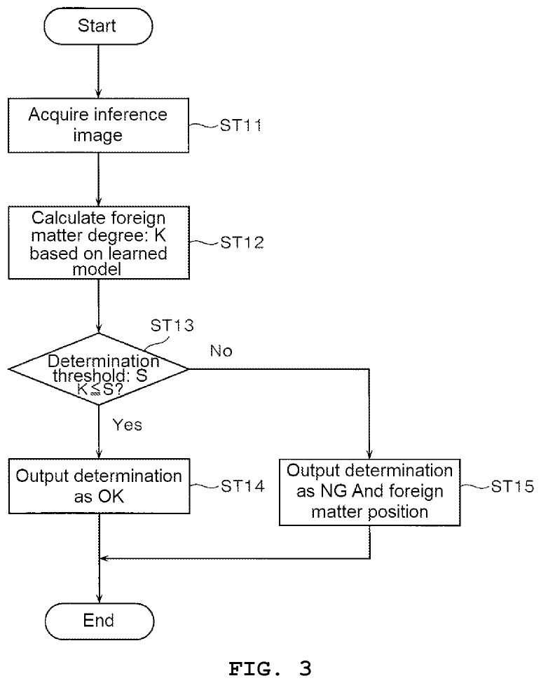

Next, an inference phase for inferring a quality state of the inspection object W in the above inspection device 1 will be described with reference to a flowchart of FIG. 3.

As shown in FIG. 3, in the inference phase, the X-ray image in the format of the multiple inspection image is acquired as an inference image i5 (ST11) in the same manner as in the learning phase described with reference to FIG. 2, and the acquired inference image i5 is stored in the image storage unit 21. Specifically, as described above, the three images are combined using the X-ray image to acquire the multiple inspection image as an inference image i5, in which the low-energy image is regarded as 1ch component, the high-energy image is regarded as 2ch component, and the difference image is regarded as 3ch component, and to store the multiple inspection image in the image storage unit 21.

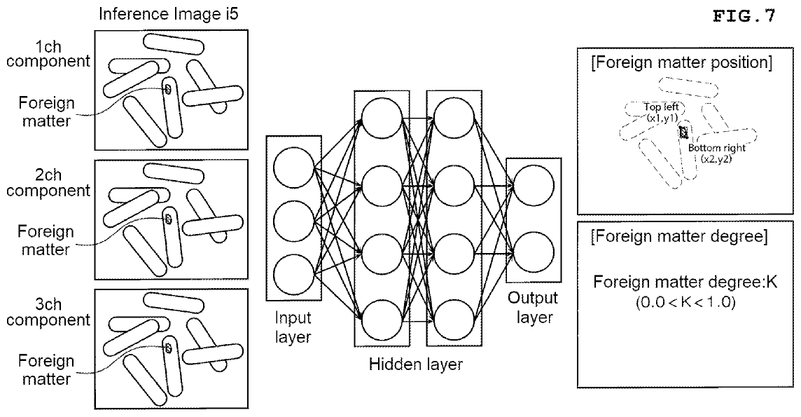

Then, the image processing unit 23 calculates the foreign matter position (top left x-y coordinates and bottom right x-y coordinates) and the foreign matter degree (0<K<1.0) (as the value of K is increased, it is regarded as a foreign matter) based on the learned model created during the learning phase (ST12). That is, as shown in FIG. 7, the 3ch multiple inspection image in which the 3ch images are combined as the inference image i5 is processed for each pixel based on the learned model 22 that is generated by machine learning using a neural network with a structure consisting of an input layer, at least a hidden layer, and an output layer, and the foreign matter position and the foreign matter degree K are calculated as calculation results.

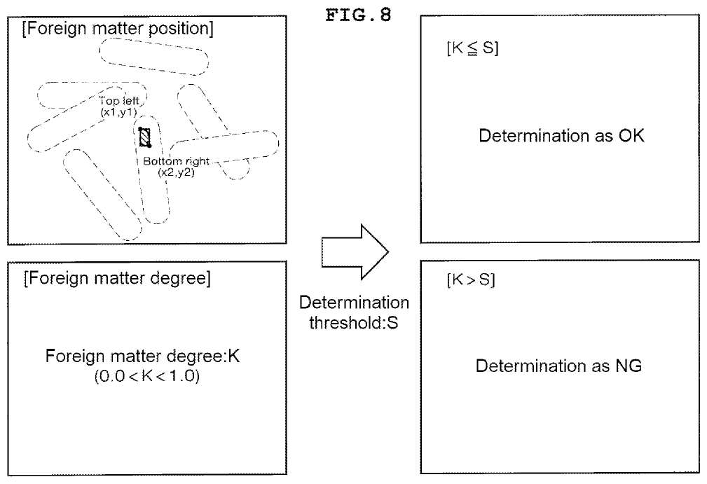

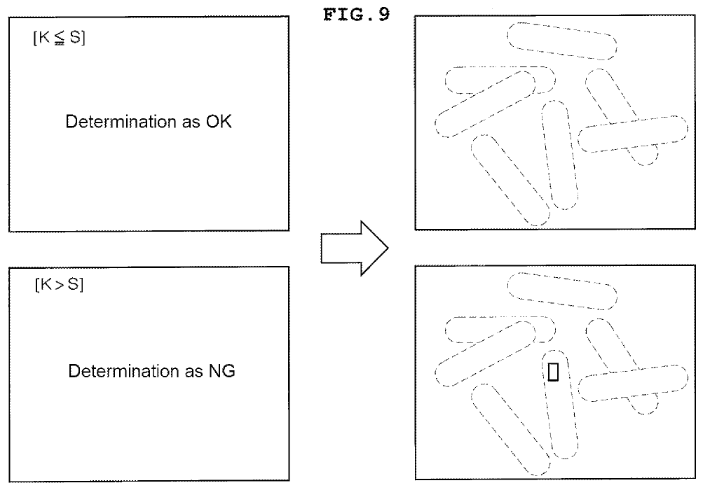

Then, a determination threshold on a side of the inspection device 1 is set to S in advance, and when K S, the determination is output as OK (ST14), and when K>S, the determination is output as NG (ST15). More specifically, as shown in FIG. 8, when K S, the determination unit 24 outputs the determination as OK, and when K>S, the determination unit 24 outputs the determination as NG. As shown in FIG. 9, when K S and the determination is output as OK, the display unit 5 displays the inspection object W (dotted line portion in the drawing), and when K>S and the determination is output as NG, the display unit 5 identifies and displays the inspection object W by enclosing the foreign matter position (NG determination location) with a rectangle. This identification display may identify the NG determination location and a normal location, such as displaying the NG determination location by color and displaying the NG determination location by lighting/blinking, in addition to enclosing the NG determination location, and the display form is not limited thereto.

In an example of FIG. 9, a case in which there is one foreign matter position in which the determination is output as NG is shown, but when there are a plurality of foreign matter positions in which the determination is output as NG, the NG determination location is identified and displayed for each foreign matter position.

Meanwhile, in the above embodiment, the X-ray image consisting of the low-energy image (1ch component), the high-energy image (2ch component), and the difference image (3ch component) has been described as an example of the 3ch image as the multiple inspection image, but the embodiment is not limited to a transmission image like the X-ray image. Moreover, the channel number of the multiple inspection image is not limited to 3ch, and may be at least 2ch or more. That is, the multiple inspection image may be an image obtained by capturing the plurality of images having different input channels for the inspection object W under the imaging conditions and obtained by the capturing (a captured image or an image created from the captured image under predetermined conditions). For example, the multiple inspection image may be a combination of an X-ray image obtained by converting a density of the image by a lookup table coefficient, a color camera image (any of R component, G component, and B component), and a near-infrared image. In addition, an image of each channel of the multiple inspection image may be subjected to image processing such as smoothing and standardization, and may correct a size, direction, and deviation of the image determined by positions and directions of an X-ray source or a light source, an optical component such as a lens, and the detector, as pre-processing. Furthermore, a plurality of inspection images, which are obtained by capturing the inspection object W with a multispectral camera (spectral camera) and spectroscopy of light (energy) transmitting through the inspection object W, can be used.

Further, the multiple inspection image can be acquired by irradiating the inspection object W with broadband light (visible light, near-infrared to terahertz light (terahertz wave)) and spectroscopy of light transmitted through the inspection object W in accordance with the irradiation of the light. That is, the plurality of inspection images, which are obtained by capturing the inspection object W with a multispectral camera (spectral camera) and spectroscopy of light (energy) transmitting through the inspection object W, can be used.

For example, a tablet as the inspection object W is irradiated with near-infrared light, and the plurality of obtained inspection images obtained by spectroscopy of the transmitted light are used to detect contained components by determining whether foreign matters that are contained in the tablet or not necessarily contained originally.

When the color camera image or the near-infrared image is used, the imaging conditions preferably include positions or directions of a light source, an optical component such as a lens, and the detector. Furthermore, when combining them, it is preferable that the imaging conditions also include position information indicating an imaging position of the inspection object W for each input channel.

In addition, in the above embodiment, a case of determining presence/absence of the foreign matter as a quality state of the inspection object W has been described, but the embodiment is not limited thereto, and it is possible to determine, as a quality state, presence/absence of missing products in the inspection object W, pass or fail of a shape, size, and storage state of contents, density, thickness, volume, or mass distribution, or the like.

Hereinafter, a case of determining the presence/absence of a shape defect of contents in the inspection object W as a quality state will be described as an example. The determination of presence/absence of a shape defect of contents in the inspection object W basically has the same structure as the case of determining presence/absence of the foreign matter described above, in which types of the NG determination are increased to two or more types (types of shape defect (chipping and bending)), the determination threshold can also be set individually according to the types of shape defect (chipping and bending), and a combination with the above foreign matter inspection can also be used.

As in the case of determining presence/absence of the foreign matter, as a learning shape defect synthesis image from the learning image, an X-ray image (synthesis of the shape defect (chipping and bending) with the non-defective product)_(1ch), the color camera image (synthesis of the shape defect (chipping and bending) with the non-defective product)_(1ch), and a near-infrared image (synthesis of the shape defect (chipping and bending) with the non-defective product)_(1ch) are created, and a learning shape defect label is created.

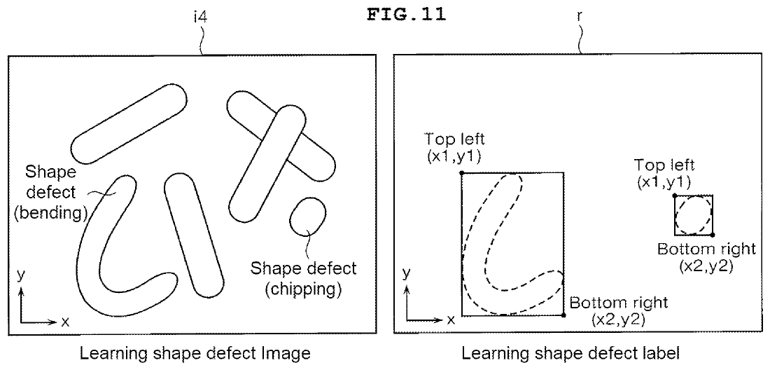

Then, one multiple inspection image (1ch component: X-ray image, 2ch component: color camera image, and 3ch component: near-infrared)_(3ch) and coordinate data of the shape defect are created from one X-ray image (synthesis of the shape defect (chipping and bending) with the non-defective product)_(1ch), one color camera image (synthesis of the shape defect (chipping and bending) with the non-defective product)_(1ch), and one near-infrared image (synthesis of the shape defect (chipping and bending) with the non-defective product)_(1ch), and for example, as shown in FIG. 11, the one multiple inspection image and the coordinate data of the shape defect are acquired as a learning shape defect synthesis image i4 and a learning shape defect label r.

As in the learning phase described with reference to FIG. 2, learning is performed by performing a convolution operation on the plurality of multiple inspection images and outputting the resulting shape defect degree (probability of shape defect) K to generate a learned model 22 consisting of a calculation formula for producing a better result.

Specifically, learning is performed using a plurality of multiple inspection images (learning shape defect synthesis image i4 extended to 3ch) and coordinate data of the shape defect (learning shape defect label r) corresponding to respective multiple inspection images. In this case, when an image of a workpiece (with shape defect) is input, learning is performed to output a shape defect position (top left X-Y coordinates and bottom right X-Y coordinates) and a shape defect degree K (0<K<1.0) (as the value of K is increased, it is regarded as a shape defect).

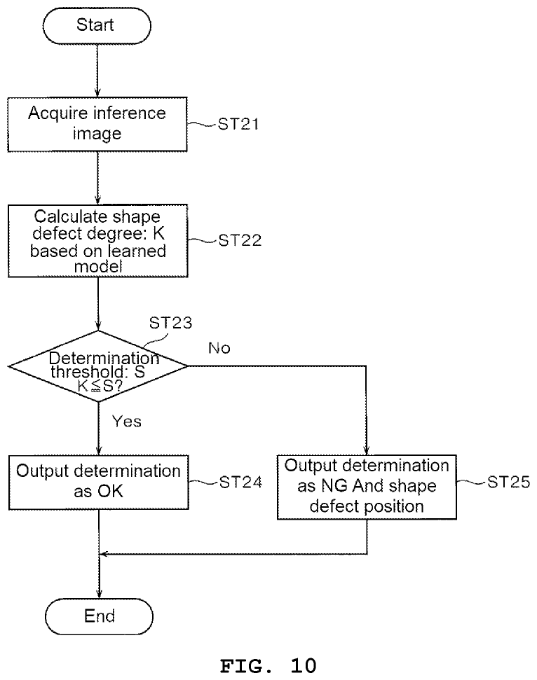

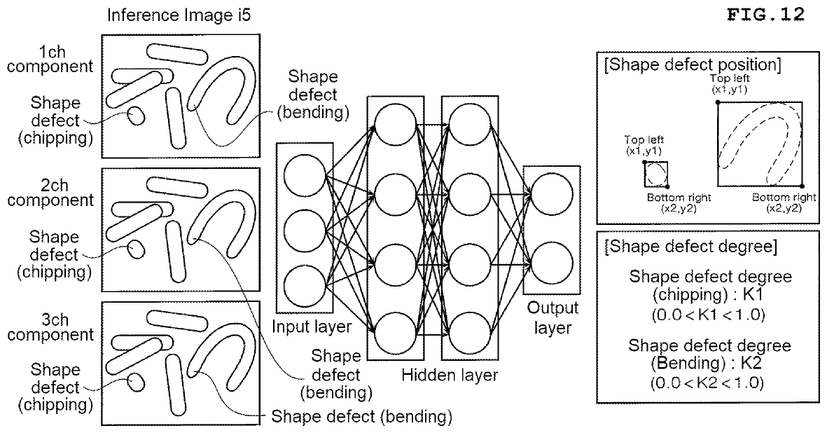

Then, when the shape defect of the inspection object W is inspected, the inference phase shown in FIG. 10 is executed. In the inference phase, the X-ray image in the format of the multiple inspection image is acquired as an inference image i5 (ST21) in the same manner as in the learning phase, and the acquired inference image i5 is stored in the image storage unit 21. Specifically, as in the case of learning described above, for example, one multiple inspection image of 1ch: X-ray image, 2ch: color camera image, and 3ch: near-infrared image is acquired as the inference image i5 to store the one pseudo RGB image in the image storage unit 21, as shown in FIG. 12.

Then, the image processing unit 23 calculates the shape defect position (top left x-y coordinates and bottom right x-y coordinates) and the shape defect degree (0<K<1.0) (as the value of K is increased, it is regarded as a shape defect) based on the learned model 22 created during the learning phase (ST22). That is, as shown in FIG. 12, the 3ch multiple inspection image as the inference image i5 is processed for each pixel based on the learned model 22, and the shape defect position (top left x-y coordinates and bottom right x-y coordinates) and the shape defect degrees: K1 (chipping) and K2 (bending) are calculated as calculation results.

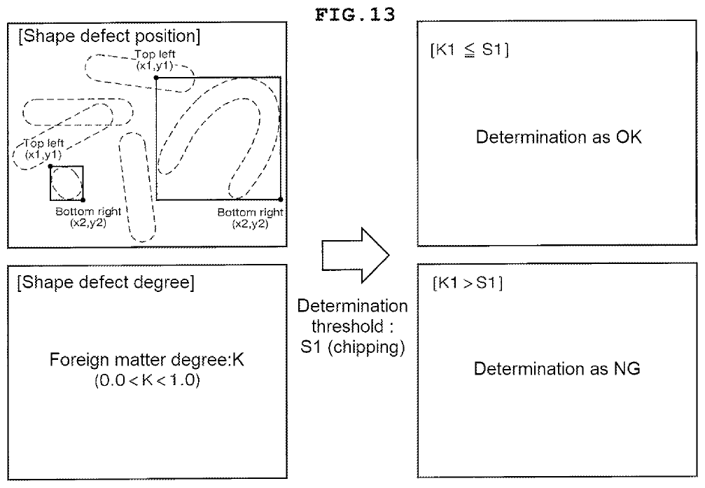

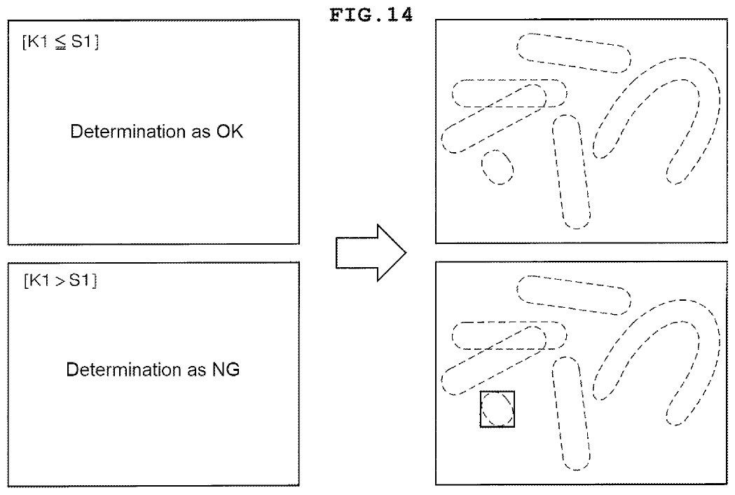

Then, a determination threshold on a side of the inspection device 1 is set to S in advance, and when K S, the determination is output as OK (ST24), and when K>S, the determination is output as NG (ST25). More specifically, determination thresholds S1 and S2 are set in advance on a side of the inspection device 1, and the calculated shape defect degrees K1 and K2 are compared with the determination thresholds S1 and S2. Here, as shown in FIG. 13, when K1 S1, the determination unit 24 outputs the determination for the shape (chipping) as OK, and when K1>S1, the determination unit 24 outputs the determination as NG. As shown in FIG. 14, when K1≤S1 and the determination is output as OK, the display unit 5 displays the inspection object W (dotted line portion in the drawing), and when K1>S1 and the determination is output as NG, the display unit 5 identifies and displays the inspection object W by enclosing the shape defect position (NG determination location) with a rectangle.

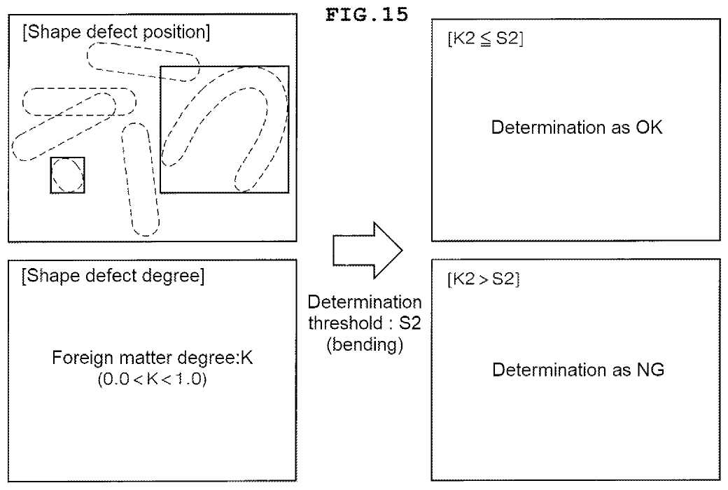

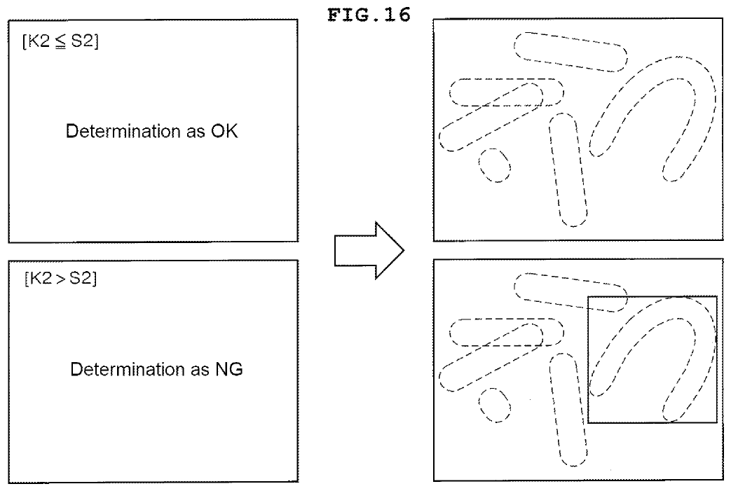

In addition, as shown in FIG. 15, when K2≤S2, the determination unit 24 outputs the determination for the shape (bending) as OK, and when K2>S2, the determination unit 24 outputs the determination as NG. As shown in FIG. 16, when K2≤S2 and the determination is output as OK, the display unit 5 displays the inspection object W (dotted line portion in the drawing), and when K2>S2 and the determination is output as NG, the display unit 5 identifies and displays the inspection object W by enclosing the shape defect position (NG determination location) with a rectangle.

The determination thresholds S1 and S2 can be set individually for each type of the shape defect (for example, chipping and bending). In addition, the above identification display may identify the NG determination location and a normal location, such as displaying the NG determination location by color and displaying the NG determination location by lighting/blinking, in addition to enclosing the NG determination location, and the display form is not limited thereto.

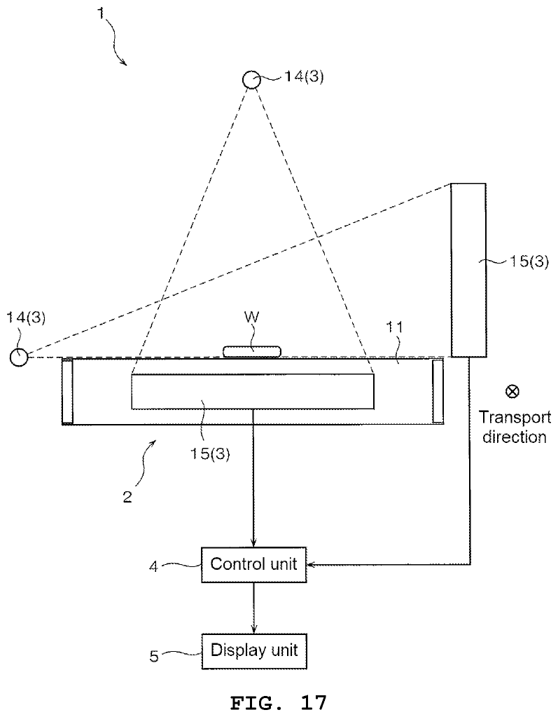

Meanwhile, in the embodiment described above, the learned model 22 is generated from an image having the same angle (same imaging direction), but for example, the learned model 22 can be created from an image having a different angle (different imaging direction). In this case, the inspection device 1 of FIG. 17 is adopted. Although an internal configuration of the control unit 4 is omitted in the inspection device 1 of FIG. 17, the configuration is the same as that of FIG. 1.

In the inspection device 1 of FIG. 17, two sets of X-ray generators 14 as the image acquisition unit 3 and X-ray detectors 15 are arranged, and the learned model 22 is created by the same method as the above learning phase by setting a set of images acquired from the two sets of X-ray generators 14 and X-ray detectors 15 as learning images.

Then, in the inference phase, the learned model 22, which is created by a set of images acquired from the two sets of X-ray generators 14 and X-ray detectors 15 having different input channels of FIG. 17, and a two set of inference images i5 (multiple inspection images) having different input channels of the same angles (same imaging directions) is acquired. Subsequently, the acquired inference image i5 is processed for each pixel based on the learned model 22, and the shape defect position and the shape defect degree: K (0<K<1.0) (as the value of K is increased, it is regarded as a shape defect) are calculated as calculation results. Then, a determination threshold on a side of the inspection device 1 is set to S in advance, and when K≤S, the determination is output as OK, and when K>S, the determination is output as NG.

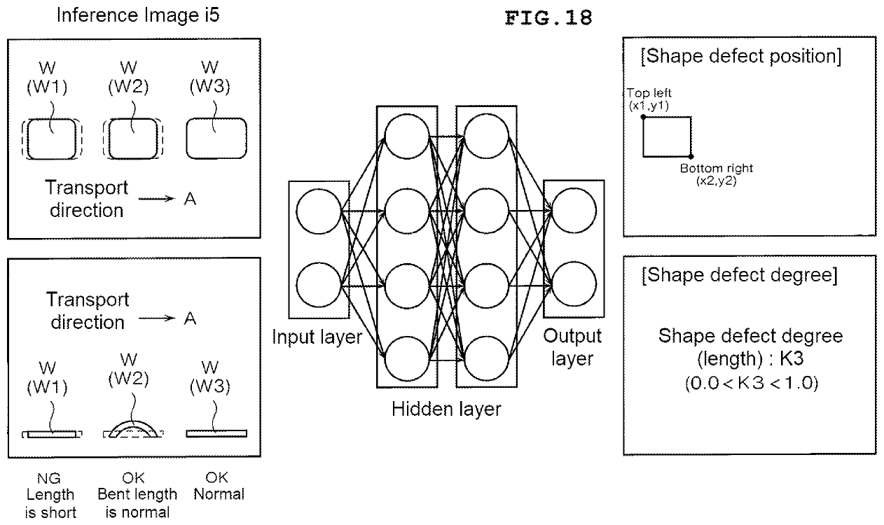

Here, FIG. 18 shows an example of image processing when lengths of respective contents W1, W2, and W3 in a longitudinal direction are inspected for a product in which, for example, the three contents W1, W2, and W3 are placed in a tray as inspection objects W inspected by the inspection device 1 of FIG. 17.

As the contents W2 of FIG. 18, K S in which the length in the longitudinal direction is a predetermined length even if it is curved upward with respect to a transport direction A, and the determination unit 24 outputs the determination as OK. On the other hand, as the contents W1 of FIG. 18, K>S in which the length in the longitudinal direction is shorter than the transport direction A, and the determination unit 24 outputs the determination as NG. When K S and the determination is output as OK, the display unit 5 displays only an appearance of workpiece of the inspection object W, and when K>S and the determination is output as NG, the display unit 5 identifies and displays the appearance of workpiece of the inspection object W by enclosing the shape defect position (NG determination location) with a rectangle.

As described above, in the inspection of the shape defect (length) of the inspection object W described above, it is not possible to determine presence/absence of the shape defect only from the image from above. Therefore, the inspection device 1 of FIG. 17 is employed, and the determination is made using images from two different angles.

When an image obtained by capturing the inspection object W from the different two angles is used, the imaging condition may include the imaging direction. Furthermore, when the detectors for capturing the inspection object W at each angle are arranged side by side along the transport direction A of the transport unit 2, the imaging condition may include dimension information indicating an arrangement position of each of the detectors.

According to the present embodiment described above, since the determination is learned by creating the learned model from the multiple inspection image in which the plurality of images obtained by capturing the plurality of images having different input channels for the inspection object are combined, it is possible to improve inspection accuracy of a quality inspection of the inspection object by comparing determination of one conventional grayscale image and increasing an amount of information for determination. When presence/absence of the foreign matter is inspected as a quality state for example, the learned model is created from the multiple inspection image by combining the plurality of images, and thus not only an appearance of the foreign matter differs depending on the type of the inspection object, but also information indicating a relationship between the foreign matter and the surroundings thereof (background) is increased, such that the foreign matter can be inspected with higher accuracy.

Although the best mode of the inspection device, learned model generation method, and inspection method according to the present invention have been described above, the present invention is not limited by the description and the drawings according to this mode. That is, it is a matter of course that other modes, examples, operation techniques, and the like made by those skilled in the art based on this mode are all included in the scope of the present invention.

### DESCRIPTION OF REFERENCE NUMERALS AND SIGNS

1: inspection device
2: transport unit
3: image acquisition unit
4: control unit
5: display unit
11: transport belt
12: transport roller
13: upper running section
14: X-ray generator
15: X-ray detector
16: X-ray tube
17: enclosure
17a: X-ray window
21: image storage unit
22: learned model
23: image processing unit
24: determination unit
A: transport direction
W: inspection object
W1, W2, W3: content
i1: image of only foreign matter
i2: non-defective image
i3: foreign matter synthesis image
i4: learning foreign matter synthesis image, learning shape defect synthesis image
i5: inference image
r: learning foreign matter label, learning shape defect label

What is claimed is:

1. An inspection device comprising:
an image storage unit that captures a plurality of images having different input channels for an inspection object (W) under a predetermined imaging condition corresponding to each input channel, and stores multiple inspection images obtained by the capturing and combining the plurality of images of the inspection object; and
a determination unit that obtains a defective quality degree for the multiple inspection images stored in the image storage unit based on a learned model created in advance by learning using an image having a same imaging condition as the multiple inspection images, and determines a quality state of the inspection object by comparison between the defective quality degree and a preset threshold.

2. The inspection device according to claim 1,
wherein the predetermined imaging condition includes at least position information indicating an imaging position of the inspection object for each input channel.

3. The inspection device according to claim 1,
wherein the learned model is associated with the imaging condition for an image used for learning.

4. The inspection device according to claim 1,
wherein the learned model is learned for each type of the inspection object with respect to the image having a same imaging condition as the multiple inspection images including at least images with a defective quality.

5. The inspection device according to claim 1,
wherein the multiple inspection images are images obtained by spectroscopy of light transmitting through the inspection object.

6. The inspection device according to claim 2,
wherein the multiple inspection images are images obtained by spectroscopy of light transmitting through the inspection object.

7. The inspection device according to claim 3,
wherein the multiple inspection images are images obtained by spectroscopy of light transmitting through the inspection object.

8. The inspection device according to claim 4,
wherein the multiple inspection images are images obtained by spectroscopy of light transmitting through the inspection object.

9. A learned model creation method comprising:
a step of acquiring a non-defective image of an inspection object (W) and an image with only defective quality of the inspection object as learning images;
a step of creating a learning defective quality synthesis image in which the image with only defective quality is synthesized with the non-defective image of the inspection object using the learning image and a learning defective quality label showing a defective quality position in the learning defective quality synthesis image; and
a step of creating a learned model by performing machine learning of the learning defective quality synthesis image.

10. An inspection method comprising:
a step of determining a quality state of an inspection object (W) by capturing a plurality of images having different input channels for the inspection object under an imaging condition corresponding to each input channel, obtaining a defective quality degree for multiple inspection images obtained by the capturing and combining the plurality of images of the inspection object, based on a learned model created using an image having a same imaging condition as the multiple inspection images by the learned model creation method of claim 9, and comparing the defective quality degree and a preset threshold.
